(19) United States
(12) Patent Application Publication
(10) Pub. No.: US 2006/0070860 A1
(43) Pub. Date: Apr. 6, 2006

(54) Structure of a conveyer belt

(76) Inventor: Yu-Ren Huang, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/957,666

(22) Filed: Oct. 5, 2004

(51) Int. Cl. B65G 17/06

(52) U.S. Cl. 198/852; 198/853; 198/850; 198/778

(57) ABSTRACT

A conveyer belt includes a panel member, a guiding member for the panel member, and a power source; the panel member includes several parts arranged one behind another, every two adjacent ones of which parts are pivoted to each other by means of a pivotal stick; each of the panel parts has holding gaps on two lateral edges, and wheels fitted in the holding gaps thereof; the guiding member includes two spaced guiding bars; the panel member is positioned between the guiding bars of the guiding member with the wheels thereof touching inward sides of the guiding bars at curved sides; thus, friction of the panel member against the guiding member is reduced.

### BACKGROUND OF THE INVENTION

1. Field of the Invention

The present invention relates to a conveyer belt, more particularly one, which is equipped with wheels between a movable panel member and a stationary guiding member for the panel member such that the panel member can move smoothly.

2. Brief Description of the Prior Art

Referring to FIG. 7, a conventional conveyer belt includes a panel member 4, and a stationary guiding member. The guiding member has two spaced guiding bars 3 having projection portions 31 opposing each other. The panel member 4 includes several panel parts 41 arranged one behind another, every two adjacent ones of which panel parts 41 are pivoted to each other by means of a pivotal stick 42. Each panel part 41 has holding gaps 411 on two lateral edges thereof. The panel member 4 is positioned between the guiding bars 3 of the guiding member with the projection portions 31 passing into the holding gaps 411.

The conveyer belt can function properly if the guiding member is straight or forms a single curve. However, if the guiding member has a spiral shape with many circles, the panel member 4 will touch the projection portions 31 at some portions thereof with too much force when moving along the spiral path. Consequently, the guiding member will interfere with, and can even stop, movement of the panel member 4. And, the user has to increase load to the power source for making the panel member 4 move at the desired speed. Consequently, service life of the power source will be shortened.

### SUMMARY OF THE INVENTION

It is a main object of the present invention to provide an improvement on a conveyer belt to overcome the above disadvantages.

The conveyer belt of the present invention includes a panel member, and a guiding member for the panel member. The panel member includes several parts arranged one behind another, every two adjacent ones of which parts are pivoted to each other by means of a pivotal stick. Each panel part has holding gaps on two lateral edges, and wheels fitted in the holding gaps. The guiding member includes two spaced guiding bars. The panel member is positioned between the guiding bars of the guiding member with the wheels touching the guiding bars for reducing friction of the panel member against the guiding member. Thus, the guiding member won't interfere with movement of the panel member. And, the panel member can move smoothly even if the guiding member forms a spiral with many circles.

### BRIEF DESCRIPTION OF THE DRAWINGS

The present invention will be better understood by referring to the accompanying drawings, wherein:

FIG. 1 is a partial exploded perspective view of a first embodiment of a conveyer belt in the present invention,

FIG. 2 is a partial vertical section of the first embodiment,

FIG. 3 is a side view of a spiral conveyer belt,

FIG. 4 is a partial vertical section of a second embodiment of a conveyer belt in the present invention,

FIG. 5 is a partial vertical section of a third embodiment,

FIG. 6 is a partial vertical section of a fourth embodiment, and

FIG. 7 is a view of the conventional conveyer belt.

### DETAILED DESCRIPTION OF THE PREFERRED EMBODIMENTS

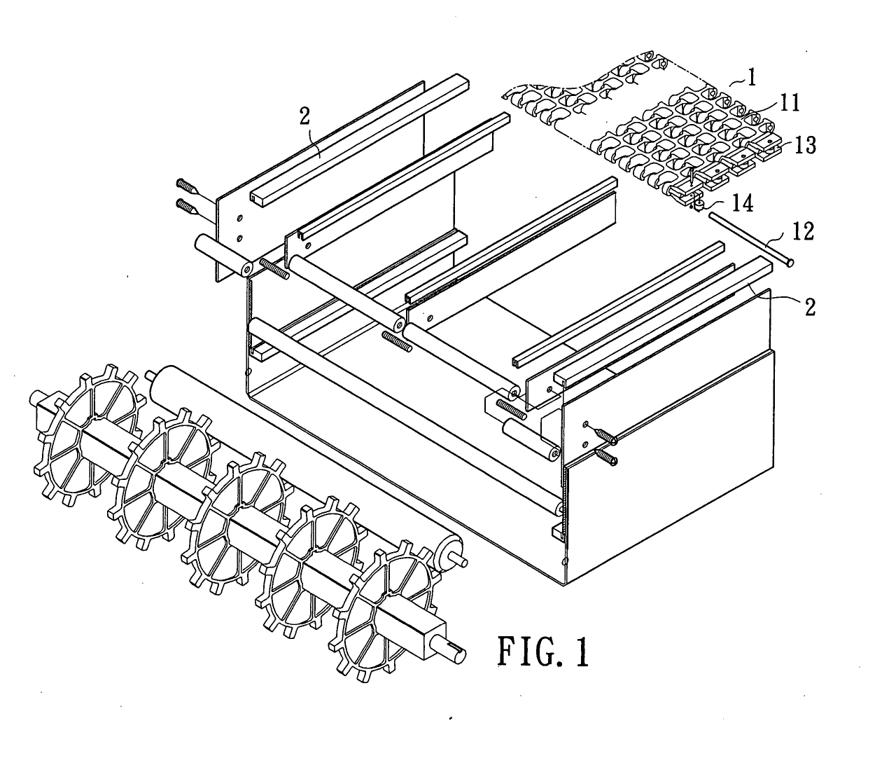

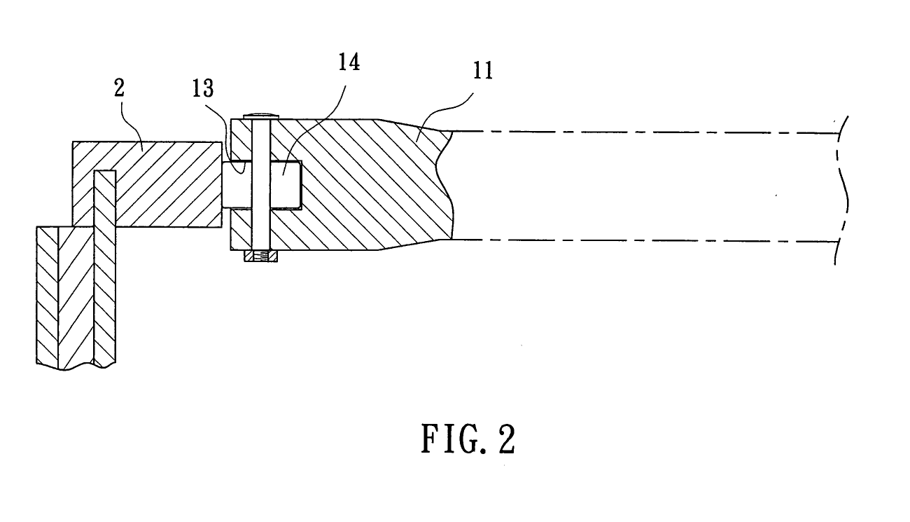

Referring to FIGS. 1 and 2, a first embodiment of a conveyer belt includes a panel member 1, a stationary guiding member for the panel member 1, and a power source (not shown) for moving the panel member 1 along the guiding member.

The stationary guiding member has two spaced guiding bars 2. And, the panel member 1 includes several separable panel parts 11 arranged one behind another, every two adjacent ones of which panel parts 11 are pivoted to each other by means of a pivotal stick 12. Each of the panel parts 11 has holding gaps 13 on two lateral edges thereof. And, wheels 14 are fitted in respective ones of the holding gaps 13 of the panel parts 11, slightly projecting out from edges of the gaps 13 and with axes thereof being perpendicular to upper and lower sides of the panel parts 11. The panel member 1 is positioned between the guiding bars 2 with the wheels 14 touching the inwards sides of the guiding bars 2 at curved sides thereof.

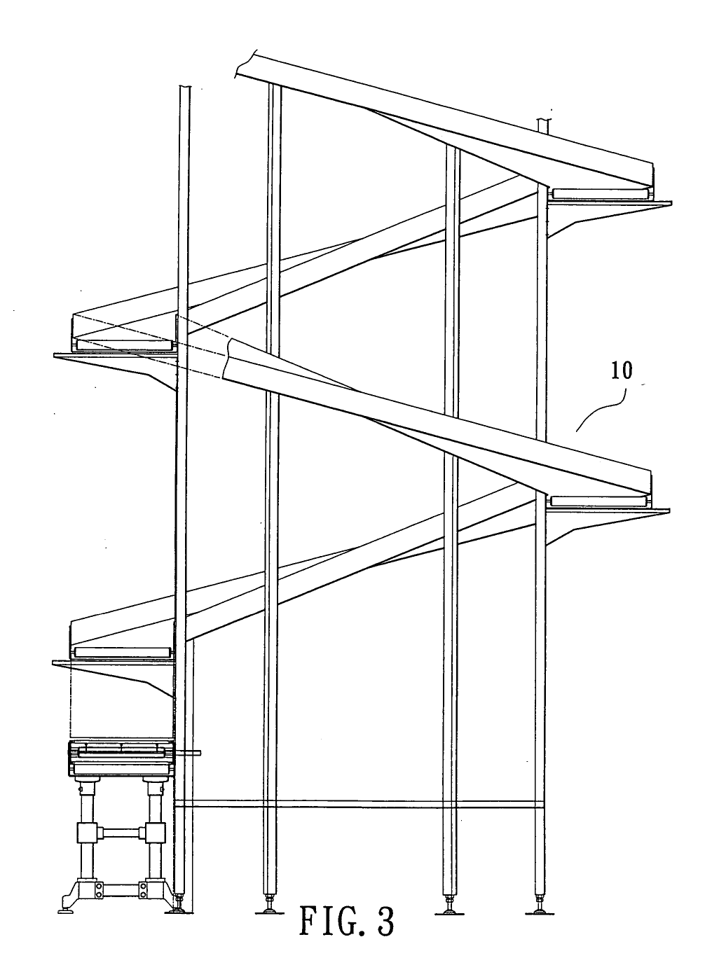

Referring to FIG. 3, when the panel member 1 is used on a guiding member 10, which is made in the shape of a spiral with many circles, the wheels 14 will help reduce friction of the panel member 1 against the spiral guiding member 10 and prevent the spiral guiding member 10 from interfering with movement of the panel member 1 along it. In other words, the panel member 1 can move smoothly, although it winds into the same spiral shape as the guiding member 10. And, the user doesn't have to increase load to the power source for making the panel member 1 move smoothly. Consequently, service life of the power source won't be shortened.

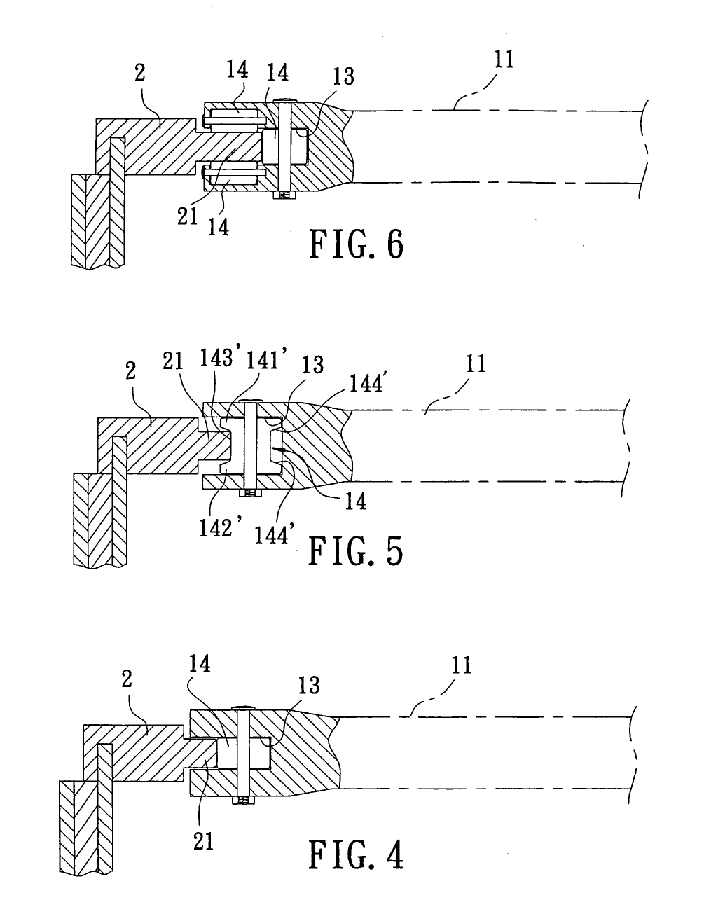

Referring to FIG. 4, a second embodiment of a conveyer belt includes panel member 1, a stationary guiding member for the panel member 1, and a power source, which panel member 1 is the same as that of the first embodiment except that wheels 14 thereof are completely hidden in holding gaps 13, not projecting out from edges of the holding gaps 13. The guiding member has two spaced guiding bars 2, which have projection portions 21 opposing each other. The panel member 1 is positioned between the guiding bars 2 of the guiding member with the projection portions 21 passing into the holding gaps 13 and touching the curved sides of the wheels 14 at the inwards sides thereof. Thus, the wheels 14 will help reduce friction of the panel member 1 against the spiral guiding member 10 and prevent the guiding member 10 from interfering with movement of the panel member 1.

In addition, each of the holding gaps 13 can have more than one wheels fitted therein instead of one in the above two embodiments.

Referring to FIG. 5, in a third embodiment, wheels 14′ are fitted in holding gaps 13 of each panel part 11 of panel member 1 instead, whose axes are perpendicular to upper and lower sides of the panel part 11, and each of which has a top portion 141′, a bottom portion 142′, and a shank portion 143′ between the top portion 141′ and the bottom portion 142′; the shank portion 143′ has a smaller diameter than the top portion 141′ and the bottom portion 142′; a lower annular side of the top portion and an upper annular side of the bottom portion 142′, which are around the shank portion 143′, are made into slopes 144′. Thus, when the panel member winds along the spiral guiding member 10 (FIG. 3) with certain portions thereof in tilting position, each of the wheels 14′ will always touch projection portions 21 of guiding bars 2 of the spiral guiding member 10 at one of the shank portion 143′ and the slopes 144′ thereof, thus helping the panel member 1 move smoothly.

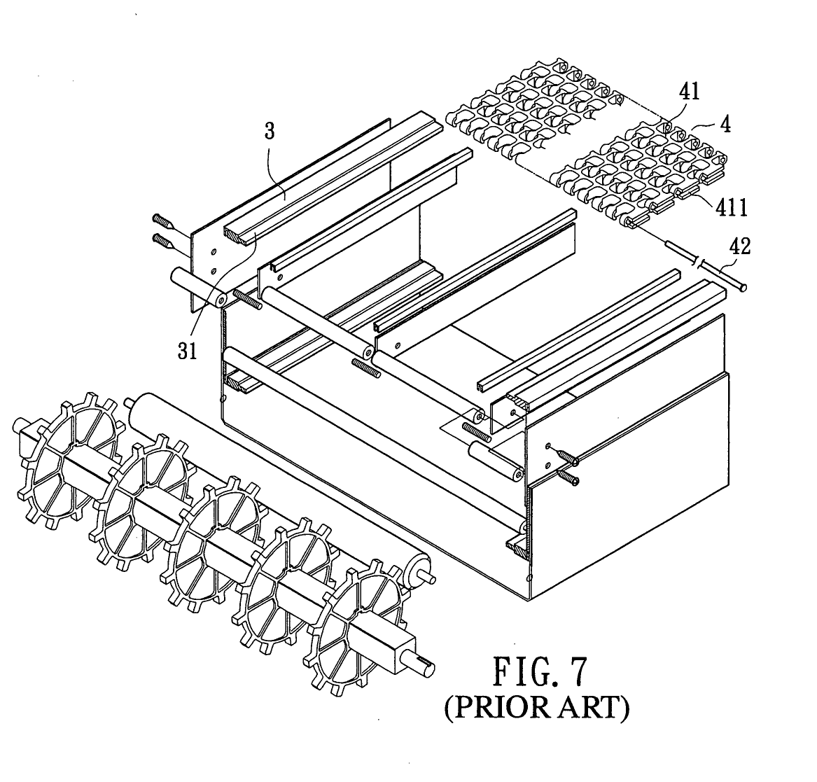

Referring to FIG. 6, in a fourth embodiment, first, second, and third wheels 14 are fitted in holding gaps 13 of each panel part 11 of panel member 1 instead; the first wheel 14 faces the inner end of a corresponding projection portion 21 with the axis thereof being perpendicular to upper and lower sides of the panel part 11 while the second and the third wheels 14 touch upper and lower sides of the corresponding projection portion 21 respectively with the axes thereof being perpendicular to the tangential lines of the lateral edges of the panel part 11 as well as the axis of the first wheel.

From the above description, it can be easily understood that the conveyer belt of the present invention has the following advantages:

1. When the conveyer belt winds into a spiral shape with several circles, the panel member can move smoothly because the wheels thereon will touch the guiding bars (the projection portions) of the guiding member to help reduce friction of the panel member against the guiding bars (the projection portions) and prevent the guiding member from interfering with movement of the panel member.

2. The power source of the conveyer belt doesn't have to be used with increased load because there is no obstruction against movement of the panel member. Consequently, service life of the power source won't be shortened.

What is claimed is:

1. A conveyer belt, comprising
a panel member; the panel member including a plurality of panel parts arranged one behind another, every two adjacent ones of which panel parts are pivoted to each other by means of a pivotal stick;
a guiding member for guiding the panel member with; the guiding member including two spaced guiding bars; and
a power source for effecting movement of the panel member along the guiding member;
each of the panel parts of the panel member having holding gaps on two lateral edges thereof; each of the panel parts having wheel sets fitted in the holding gaps thereof; the wheel sets projecting out from corresponding holding gaps from at least one wheel thereof; the panel member being positioned between the guiding bars of the guiding member with the wheel sets thereof touching inward sides of the guiding bars at curved sides.

2. The conveyer belt as claimed in claim 1, wherein the spaced guiding bars of the guiding member have projection portions opposing each other, and the wheel sets are completely hidden in corresponding holding gaps instead of projecting out; the panel member is fitted on the projection portions of the guiding bars at the holding gaps with the wheel sets touching inward sides of the projection portions at curved sides.

3. The conveyer belt as claimed in claim 2, wherein each wheel of the wheel sets has a top portion, a bottom portion, a shank portion between the top portion and the bottom portion; the shank portion having a smaller diameter than the top portion and the bottom portion; a lower annular side of the top portion and an upper annular side of the bottom portion of each wheel being made into slopes.

4. The conveyer belt as claimed in claim 2, wherein each of the wheel sets of the panel member includes first, second, and third wheels, which first wheel is positioned in such a way that an axis thereof is perpendicular to upper and lower sides of the panel part, and which second and third wheels are positioned such that they touch upper and lower sides of the guiding member respectively, and such that axes thereof are parallel with the upper and the lower sides of the panel part.

5. The conveyer belt as claimed in claim 4, wherein each of the first wheels of the wheel sets has a top portion, a bottom portion, a shank portion between the top portion and the bottom portion; the shank portion having a smaller diameter than the top portion and the bottom portion; a lower annular side of the top portion and an upper annular side of the bottom portion of each wheel being made into slopes.

6. The conveyer belt as claimed in claim 2, wherein each wheel of the wheel sets is positioned in such a way that an axis thereof is perpendicular to upper and lower sides of the panel part, and each wheel has a top portion, a bottom portion, a shank portion between the top portion and the bottom portion; the shank portion having a smaller diameter than the top portion and the bottom portion; a lower annular side of the top portion and an upper annular side of the bottom portion of each wheel being made into slopes.
